(19) United States
(12) Patent Application Publication
(10) Pub. No.: US 2025/0048496 A1
(43) Pub. Date: Feb. 6, 2025

(54) ENCLOSURE FOR A CERAMIC HEATER ROD

(71) Applicant: HOT Brands, LLC, Marrero, LA (US)

(72) Inventor: Stephen Smith, Marrero, LA (US)

(21) Appl. No.: 18/230,166

(22) Filed: Aug. 4, 2023

(51) Int. Cl. H05B 3/02; H05B 3/42

(52) U.S. Cl. CPC H05B 3/02; H05B 3/42

(57) ABSTRACT

An enclosure for a ceramic heater rod installed within an interior wall of a sauna is disclosed. Such an enclosure may include a rectangular member having a concave rear surface and an open front surface facing the interior of the sauna. The enclosure may further comprise two spring clips into which a ceramic heater rod is affixed. The rod may further comprise a current wire and a ground wire which terminate at plugs which interface with corresponding plugs on current and ground wires within the sauna. Finally, the enclosure may include a cover that prevents contact with the rod while the sauna is in use. The cover is attached to the sauna wall at one end by one or more hinge member, and by one or more magnets at the opposite end such that a magnetic force holds the cover in place when it is in the closed position.

### FIELD OF THE INVENTION

The present invention is generally related to enclosures for ceramic heater rods, and, more particularly, to an enclosure for a ceramic heater rod installed within an infrared sauna.

### CROSS-REFERENCES TO RELATED INVENTIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

Wellness trends of the past 5 years have demonstrated an exponential increase in the sale and use of infrared saunas, both in-home and at health/fitness clubs and spas. Types of currently available infrared sauna heaters emit near, mid, to far-infrared wavelengths. Near-infrared saunas typically combine heat and light therapy (phototherapy) which is absorbed just beneath the surface of the skin. Mid-infrared heaters emit slightly longer wavelength than near-infrared to penetrate deeper beneath the surface of the skin. Finally, far infrared heaters emit light in the far-infrared range.

Far infrared saunas have become particularly popular in gyms, spas, and other wellness establishments. Far infrared saunas heat an occupant's body directly, rather than the air around the occupant. Thus, it is generally believed that far infrared saunas are more comfortable than their near and mid counterparts, as the surrounding air is relatively cooler and drier.

Far infrared saunas typically employ one or more of three types of heaters—ceramic, carbon fiber, and ceramic-carbon combination heaters. Of these three options, ceramic heaters are the most widely used, as they are generally less expensive than the others. Ceramic heaters employ a ceramic rod to generate heat. When in operation, an electric current is introduced into the rod, which results in the rod emitting both ambient heat and infrared light.

Due to the cylindrical shape of most ceramic heater rods, the rods typically emit infrared light in all directions about the axis of the cylinder. Accordingly, ceramic heater rods utilized in saunas are typically used in combination with an enclosure configured to reflect infrared light into the sauna space that would otherwise travel in an outward direction in order to increase the infrared light in the sauna interior, and to protect sensitive electronics and wiring behind the enclosures from excessive heat. Such enclosures are generally open at the end facing the interior of the sauna, and closed at the opposite end, with the opposite end either made from or coated with a material that reflects infrared light back towards the sauna interior. Due to the high surface temperatures of ceramic heater rods when in use, the open end of the enclosure may be covered to prevent inadvertent physical contact with a rod while it is in operation.

Many currently available ceramic heater rods last approximately 5,000 hours. Therefore, for many commercial or high-use saunas, the rods must be changed approximately four times per year. However, the design of most presently available ceramic heater rod enclosures does not allow for efficient changeout of the rods contained therein. For example, most presently available enclosures must be completely removed from a sauna wall to change the rods therein, which must then be unscrewed from the wires supplying current to the rods. Rods are often secured to said enclosure by metal wire members having sharp edges suspended between hook members, which can result in injury to users when the tension in the wire is released upon removal from the hook members. Other currently available enclosures may forego the use of wire members, but secure heater rods therein by other means that require the removal of the enclosure from the sauna in order to remove and replace the rod. For example, currently available enclosures marketed by Otomatico secure heater rods by holes through the side members of the enclosures such that each end of a heater rod protrudes through said holes when the rod is affixed therein. However, while such arrangements eliminate the use of tensioned wire members to affix heater rods in place, the enclosure must nevertheless be removed from a sauna to remove and replace the rod. Finally, the wiring for the ceramic heater rods is often positioned behind current enclosures and can be punctured when screwing said enclosures back into a sauna.

It is therefore an object of the present invention to provide an enclosure for a ceramic heater rod used in an infrared sauna configured to allow a user to change a rod positioned therein without removing the enclosure from the sauna, while protecting wiring therein from damage and the user from injuries while changing the rod.

### SUMMARY OF THE INVENTION

Due to the inefficiencies and dangers inherent with currently available enclosures for ceramic heater rods for use within far infrared saunas, it is an object of the present invention to provide an enclosure for a ceramic heater rod that, when installed within the interior wall of a sauna, facilitates the removal and replacement of the heater rod therein without the need for removing the enclosure from the sauna wall. Features of the present invention may further reduce risk of injury to a user removing and/or replacing the ceramic heater rod and provide protection for the wiring of the ceramic heater rod.

According to an exemplary embodiment of the present invention, an enclosure for a ceramic heater rod may comprise a top wall, a bottom wall, a left side wall with a notch, an right side wall with a notch, a left spring clip, a right spring clip, a rear surface having at least one vertex such that the rear surface has a concave shape, and a ceramic heater rod having a left end and a right end. The top, bottom, left, and right side walls may be arranged to form a rectangular enclosure, with the rear surface positioned therein. The let spring clamp may be positioned externally of the rectangular enclosure and in line with the left side wall notch, and the right spring clamp may be positioned externally of the enclosure and in line with the right side wall notch. The ceramic heater rod may be affixed within the left and right spring clamps such that the left end of the heater rod passes through the left side wall notch and the right end of the heater rod passes through the right side wall notch. In some embodiments, at least the rear surface of the enclosure may be comprised of a material capable of reflecting radiant energy emitted by the ceramic heater rod such that the concave rear surface is configured to reflect radiant energy from the heater rod towards the interior of a sauna when the enclosure is installed in an interior wall of the sauna.

The positioning of the spring clips facilitates a user being able to install or remove a ceramic heater rod within an enclosure installed in an interior sauna wall without having to remove the enclosure itself. The ceramic heater rod may further comprise a wire at each end of the rod (i.e., a left wire and a right wire), with one of the wires responsible for delivering a current to the rod and the other being a ground wire. In furtherance of the object of the invention, the left wire and the right wire may be configured to interface with corresponding current or ground supply wires originating from behind the wall of the sauna within which the enclosure is installed via a left plug and a right plug. Accordingly, a user may remove or replace a ceramic heater rod within an enclosure as disclosed by applying sufficient pressure to the rod as to engage or disengage it from the spring clips, then either plug or unplug the left wire and the right wire from the corresponding internal wiring from the sauna.

Finally, certain embodiments of the present invention may further comprise a cover member that attaches to the sauna wall at one end by at least one hinge member, and by one or more magnet members at the opposite end of the cover member. In the closed position, the one or more magnet members is magnetically affixed to the sauna wall—or a suitable material affixed to the sauna wall—such that the ceramic heater rod is covered, thus preventing contact therewith while the sauna is in use. To remove or replace the ceramic heater, a user may apply sufficient force as to interrupt the magnetic force such that the cover member pivots about the one or more hinge members to reveal the enclosure structure therein.

### BRIEF DESCRIPTION OF THE DRAWINGS

FIG. 1 is a front left perspective view of a currently available enclosure for a ceramic heater rod.

FIG. 2A is a front left perspective view of a currently available enclosure for a ceramic heater rod.

FIG. 2B is a partial front view of a currently available heater rod after removal from a currently available enclosure for a ceramic heater rod.

FIG. 3 is a front view of an enclosure for a ceramic heater rod according to an exemplary embodiment of the present invention.

FIG. 4A is a front perspective view of an enclosure for a ceramic heater rod according to an exemplary embodiment of the present invention.

FIG. 4B is a rear view of an enclosure for a ceramic heater rod according to an exemplary embodiment of the present invention.

FIG. 5 is a front left perspective view of an enclosure for a ceramic heater rod according to an exemplary embodiment of the present invention.

### DETAILED DESCRIPTION

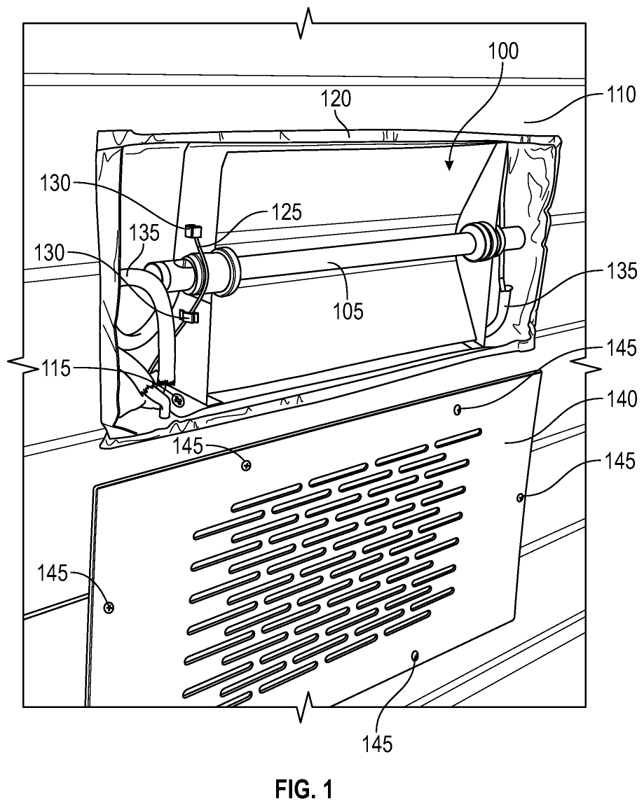

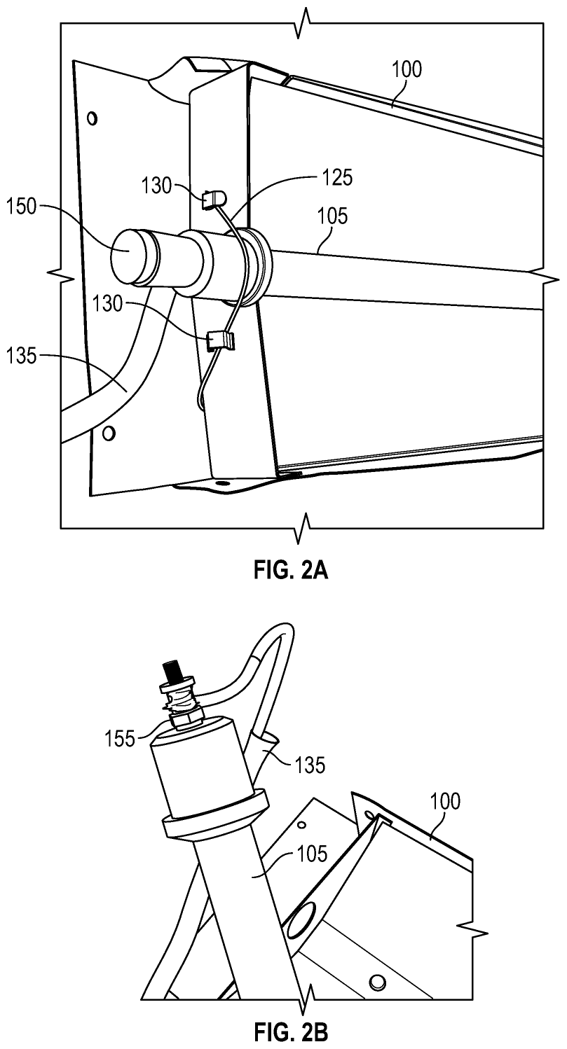

FIG. 1 is a front left perspective view of a currently available enclosure 100 for a ceramic heater rod 105. Enclosure 100 may be secured in a recession or recessed portion of sauna wall 110 and secured in place with one or more screws or other appropriate fasteners 115. The outward facing surfaces of said recession or recessed portion may be coated with a radiant barrier or other reflective material 120 to protect electronics and other materials behind sauna wall 110 from radiant energy emanating from heater rod 105. Heater rod 105 may be secured in place within enclosure 100 via one or more wire members 125, the ends of which are held in place by hook members 130, thereby creating a tension force within wire members 125. Wiring 135 may be connected to either end of heater rod 105 and used to deliver current to heater rod 105. As configured, a portion of wiring 135 is positioned behind or underneath enclosure 100, which can lead to damage of wiring 135 when enclosure 100 is reinstalled via screws 115, as one or more screws 115 may penetrate wiring 135, causing damage. When the sauna is in use, enclosure 100 may be covered with cover 140 to prevent direct contact with heater rod 105. When it is necessary to change heater rod 105, a user must first remove cover 140 by unscrewing one or more screws 145. The entirety of enclosure 100 is then removed from a recession in wall 110 by removal of fasteners 115. Once heater rod 105 has been changed as described below with respect to FIGS. 2A and 2B, enclosure 100 must be reinstalled in a recession in wall 110 by reinserting fasteners 115. However, due to the lack of a channel or other space underneath enclosure 110 to accommodate wiring 135, users risk puncturing wiring 135 with fasteners 115 upon reinsertion, thereby damaging wiring 135.

FIG. 2A is a front left perspective view of a currently available enclosure 100 for a ceramic heater rod 105. After removal from sauna wall 110, a user may proceed with removing heater rod 105 from enclosure 100. When in use, heater rod 105 is held in place by wire 125, which is compressed between hook members 130. A user may remove heater rod 105 by compressing wire 125 until it clears hook members 130, however, a sudden release of tension in wire 125 may cause injury to the user. Upon removal of heater rod 105, the point where wiring 135 interfaces with heater rod 105 may be accessed by removing cap 150.

FIG. 2B is a front view of heater rod 105 after removal from a currently available enclosure 100. After removal of cap 150, a user may complete the removal of heater rod 105 by uncoupling wiring 135 by loosening or removing fastener 155. A new heater rod 105 may then be installed by reversing the aforementioned steps as discussed above regarding FIGS. 1, 2A, and 2B. A new rod 105 may first be coupled to wiring 135 via fastener 155. After cap 150 is affixed, heater rod 105 can be placed into enclosure 100 and fixed in place via wire 125, which is compressed between hook members 130. After insertion into a recessed portion of sauna wall 110, enclosure 100 may be fixed in place via fasteners 115, which may result in damage to wiring 135. Finally, cover 140 may be affixed over enclosure 100 via fasteners 145. The process for removing and replacing heater rod 105 can be time consuming and may result injury to the user from the manipulation of wire 125, as well as damage to wiring 135.

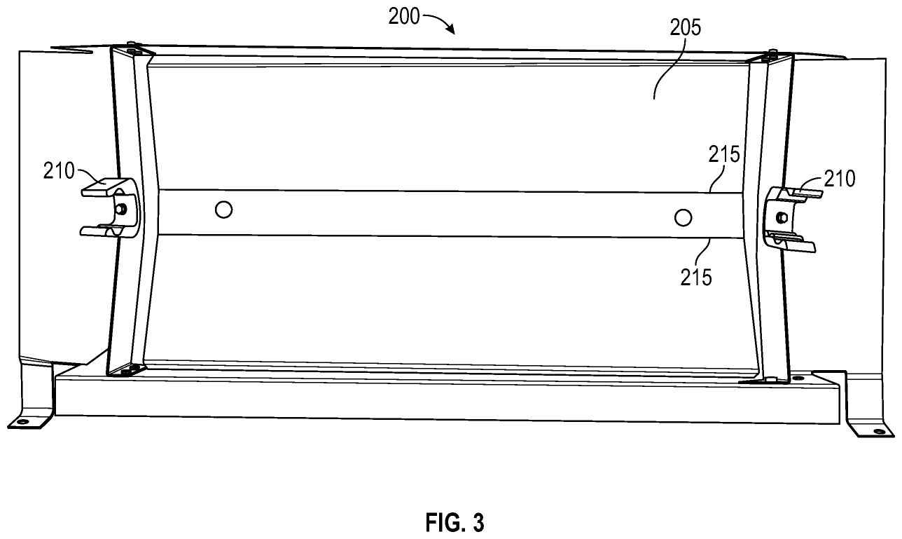

FIG. 3 is a front view of an enclosure for a ceramic heater rod according to an exemplary embodiment of the present invention. Enclosure 200 may include rear surface 205. In certain embodiments, rear surface 205 may include at least one vertex 215, giving rear surface a concave shape. Thus, when enclosure 200 is installed in a recessed portion of a sauna wall, rear the concave shape of rear surface 205 is configured to reflect radiant energy emanating from a heater rod horizontally affixed between spring clamps 210. In some embodiments, rear surface 205 may have two vertices 215 such that the area between vertices 215 defines a flat, rectangular surface. In those embodiments, a ceramic heater rod may be horizontally affixed between spring clamps 210 such that said rod is approximately vertically centered above the flat surface defined by vertices 215.

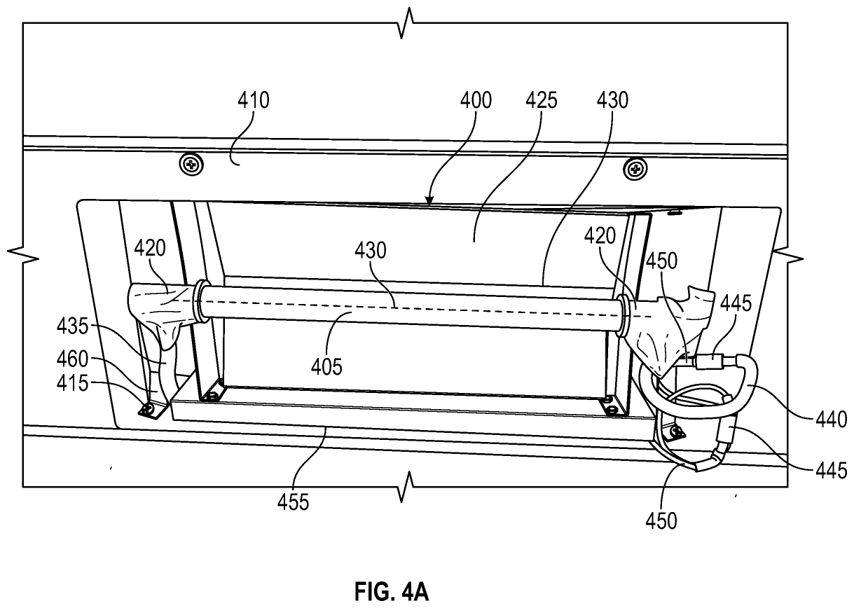

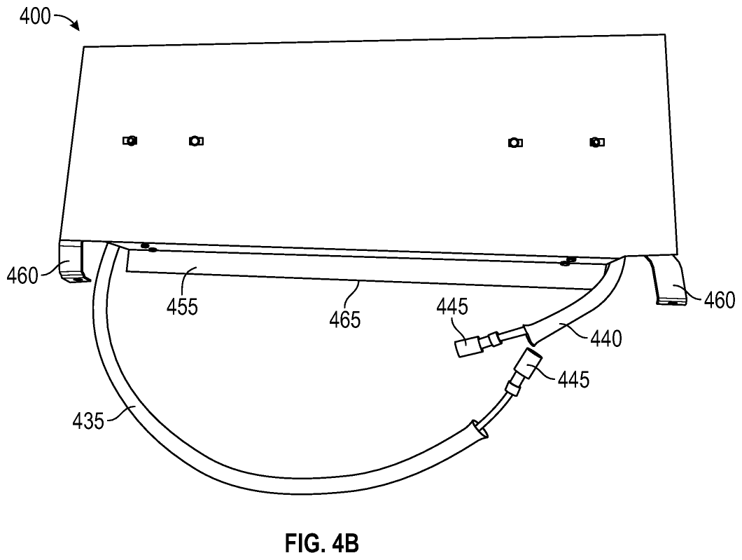

FIG. 4A is a front perspective view of an enclosure for a ceramic heater rod according to an exemplary embodiment of the present invention. In an exemplary embodiment, enclosure 400 may be installed within a recession or recessed portion of sauna wall 410 and secured therein via one or more fasteners 415. Ceramic heater rod 405 may be horizontally affixed within enclosure 400 between two spring clamps 420, wherein the spring clams are horizontally positioned at opposite ends of enclosure 400 such that each clamp 420 is configured to receive an opposite end of ceramic heater rod 405. In some embodiments, clamps 420 may be open-ended spring clamps configured such that installation and removal of heater rod 405 therein may be accomplished by a user applying sufficient force in an inward or outward direction, respectfully. Enclosure 400 may further include rear surface 425, which may be configured to reflect radiant energy emanating from heater rod 405 in an outward direction—that is, away from sauna wall 410 and into the interior space of a sauna. Accordingly, in some embodiments, rear surface 425 may have a concave shape having two vertices 430 such that the two vertices 430 defining a flat, rectangular area between them. Accordingly, heater rod 405 may be vertically positioned over the center of the flat, rectangular area defined between the two vertices 430.

Heater rod 405 may include wiring 435 and 440 attached to opposite ends of heater rod 405. In certain embodiments wiring 435 and 440 interface with internal sauna wiring 450. Typically, wiring 435 and 440 interface with internal wiring 450 on one side of enclosure 400. Accordingly, enclosure 400 may further include channel 455 positioned on the bottom side of enclosure 400 to accommodate wiring therein. For example, in the exemplary embodiment depicted in FIG. 4, channel 455 accommodates wiring 435 as it traverses the length of enclosure 400 to the right side of enclosure 400, where wiring 435 and 440 interface with internal wiring 450 via plugs 445. Wiring 435 and 440 interfaces with internal wiring 450 via plugs 445, which facilitate the removal or replacement of heater rod 405 without the need to remove any caps or fasteners, as depicted in FIGS. 2A and 2B at reference numbers 150 and 155. Wiring 435 and 440 may be any arrangement necessary to deliver adequate current for the operation of ceramic heater rod 405. For example, in certain embodiments, wiring 435 may deliver current to rod 405, and wiring 440 may be a ground wire. Wiring 435 (current) and 440 (ground) may then interface with corresponding internal wiring (i.e., a current wire and a ground wire) via plugs 445.

FIG. 4B is a rear view of enclosure 400 to better show channel 455, according to an exemplary embodiment of the present invention. Channel 455 receives wiring 435 as it traverses along the bottom of enclosure 400. In certain embodiments, channel 455 may be defined by the underside of enclosure 400 and lip 465.

While the features of the exemplary embodiment of FIGS. 4A and 4B facilitate the removal and replacement of heater rod 405 without the need for removal of enclosure 400 from the recessed portion of sauna wall 410, some embodiments include features to protect wiring 435 and 440 from damage during removal or installation of enclosure 400. For example, channel 455, which may receive wiring 435 or 440, may protect said wiring from damage from damage. Additionally, certain embodiments may include strut members 460, through which fasteners 415 are driven to secure enclosure 400 to a recessed portion of sauna wall 410. Thus, in certain embodiments, strut members 460 may be positioned away from wiring 435 and 440, as well as from channel 455, in order to avoid damage to wiring 435 and 440 during installation and removal of enclosure 400 from sauna wall 410.

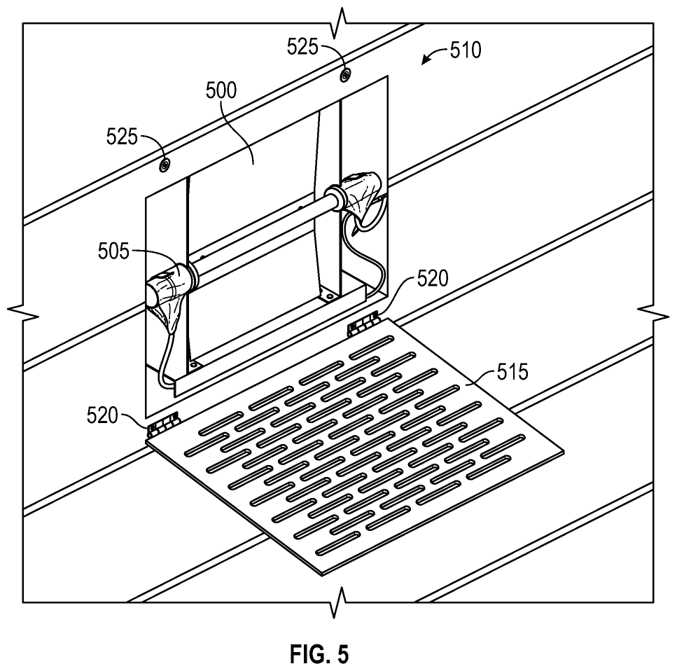

FIG. 5 is a front left perspective view of a ceramic heater rod enclosure 500 according to an exemplary embodiment of the present invention. Enclosure 500 may contain ceramic heater rod 505 and may be installed in a recessed portion of sauna wall 510. In order to protect sauna users from direct contact with heater rod 505, certain embodiments of the present invention may further include cover 515, which may be positioned over enclosure 500 and affixed to sauna wall 510. In certain embodiments, cover 515 may be affixed to sauna wall 510 via hinge members 520 in order to facilitate the efficient removal and replacement of heater rod 505. For example, one side of cover 515 may be affixed to sauna wall 510 via hinge members 520 such that cover 515 pivots about the side affixed to said hinge member 520. When cover 515 is pivoted to cover enclosure 500, cover 515 may affix to sauna wall 510 via magnet members 525. In some embodiments, cover 515 may be made of any suitable material, such as a metal, that would be held in place by magnet members 525 upon contact therewith. In certain embodiments, a magnet member 525 may comprise a radial or ring magnet through which a fastener, such as a screw, is driven such that the fastener affixes the magnet-fastener combination to wall 510. Accordingly, in order to access heater rod 505, such as for removal and/or replacement, a user may apply sufficient pressure to dislodge one end of cover 515 from magnet members 525 and pivot cover 515 downward to reveal enclosure 500 and heater rod 505. These steps may be conducted in reverse to affix cover 515 to magnet members 525, thereby protecting sauna users from direct contact with heater rod 505 via cover 515.

While the embodiments of the present invention are described herein with reference to various implementations and exploitations, it will be understood that these embodiments are illustrative and that the scope of the invention(s) is not limited to them. In general, embodiments of an enclosure for a ceramic heater rod as described herein may be implemented using devices and materials consistent with any appropriate desired structure. Many variations, modifications, additions, and improvements are possible.

For example, plural instances may be provided for components, operations, or structures described herein as a single instance. Boundaries between various components, operations, and functionality are depicted somewhat arbitrarily, and particular operations are illustrated within the context of specific illustrative configurations. For example, certain drawings contained herein illustrate particular arrangements of enclosures according to certain embodiments of the present invention. But these arrangements are for illustrative purposes only, and the present invention is in no way limited to said arrangements. Enclosures are available in multiple sizes, and the present invention is intended to cover any arrangement and/or configuration of as may be required for a given deployment of an enclosure for a ceramic heater rod according to the present invention. In general, structures presented as separate components in the exemplary configurations may be implemented as a combined structure. Similarly, structures presented as a single component may be implemented as separate components or steps. These and other variations, modifications, additions, and improvements may fall within the scope of the inventive subject matter. While certain embodiments of the present invention reference the invention as an enclosure for a ceramic heater rod for installation in a far infrared sauna, it will be understood that the present invention is not limited to such deployments, but may also implemented anywhere where ceramic heater rods are utilized.

What is claimed is:

1. An enclosure for a ceramic heater rod, comprising:
a top wall;
a bottom wall;
a left side wall having a notch;
a right side wall having a notch;
a left spring clip;
a right spring clip;
a rear surface having at least one vertex such that the rear surface has a concave shape; and
a ceramic heater rod having a left end and a right end,
wherein the top wall, bottom wall, left side wall, and right side wall are arranged to form a rectangular enclosure;
wherein the rear surface is positioned within the rectangular enclosure;
wherein the left spring clamp is positioned externally of the rectangular enclosure and in-line with the left side wall notch;
wherein the right spring clamp is positioned externally of the rectangular enclosure and in-line with the right side wall notch; and
wherein the ceramic heater rod is affixed within the left spring clamp and the right spring clamp such that the left end of the ceramic heater rod passes through the left side wall notch and the right end of the ceramic heater rod passes through the right side wall notch.

2. The enclosure of claim 1, wherein the rear surface is comprised of a material capable of reflecting radiant energy emitted by the ceramic heater rod such that the rear surface is configured to reflect radiant energy from the ceramic heater rod towards the interior of a sauna when the enclosure is installed in an interior wall of the sauna.

3. The enclosure of claim 2, wherein the ceramic heater rod further comprises:
a left wire originating from the left end of the ceramic heater rod and terminating at a left plug; and
a right wire originating from the right end of the ceramic heater rod and terminating at a right plug,
wherein the left wire and the right wire are configured to deliver one of a current or a ground to the ceramic heater rod; and
wherein the left wire and the right wire are configured to interface with corresponding current or ground supply wires behind the wall of the sauna via the left plug and the right plug when the enclosure is installed in an interior wall of a sauna.

4. The enclosure of claim 3, further comprising:
a rectangular cover member having a top edge and a bottom edge,
wherein the top edge is magnetically affixed to an interior wall of a sauna;
the bottom edge is affixed to the interior wall of the sauna via at least one hinge member; and
wherein the rectangular cover member is configured such that it covers the enclosure and the ceramic heater rod when the enclosure is installed within the interior wall of the sauna.

5. A method for removing and replacing a ceramic heater rod from an enclosure installed in an interior wall of a sauna, comprising the steps of:
applying sufficient pressure to a top edge of a rectangular cover member to disengage a magnetic seal affixing the top edge to the interior wall of the sauna;
pivoting the cover member about at least one hinge member affixing a bottom edge of the cover member to the interior wall of the sauna to reveal the enclosure;
unplugging a left wire originating from a left end of a first ceramic heater rod from a first interior wire originating from within the interior wall of the sauna;
unplugging a right wire originating from a right end of the first ceramic heater rod from a second interior wire originating from within the interior wall of the sauna;
applying sufficient pressure to disengage the left and right ends of the first ceramic heater rod from corresponding left and right spring clips affixed to the enclosure;
providing a second ceramic heater rod having a second left wire originating from a second left end and a second right wire originating from a second right end;
applying sufficient pressure to engage the second left and second right ends of the second ceramic heater rod into the corresponding left and right spring clips affixed to the enclosure;
plugging the second right wire into the second interior wire originating from within the interior wall of the sauna;
plugging the second left wire into the first interior wire originating from within the interior wall of the sauna; and
pivoting the cover member about at least one hinge member until the top edge of the rectangular cover member magnetically attaches to the interior wall of the sauna such that the enclosure is concealed behind the rectangular cover member.
